(19) United States
(12) Patent Application Publication
(10) Pub. No.: US 2023/0236014 A1
(43) Pub. Date: Jul. 27, 2023

(54) Inertial Sensor Module

(71) Applicant: SEIKO EPSON CORPORATION, Tokyo (JP)

(72) Inventor: Taketo CHINO, Hokuto (JP)

(21) Appl. No.: 18/158,066

(22) Filed: Jan. 23, 2023

(30) Foreign Application Priority Data
Jan. 24, 2022 (JP) 2022-008515

(51) Int. Cl. G01C 21/16

(52) U.S. Cl. CPC G01C 21/16

(57) ABSTRACT

An inertial sensor module includes: a plurality of inertial sensors including a first inertial sensor and a second inertial sensor that have different detection ranges; a processing unit configured to process detection signals of the plurality of inertial sensors and output inertial outputs; a transmission unit configured to transmit the inertial outputs to a host; and a reception unit configured to receive processing information from the host. The processing unit is configured to process at least one of the detection signals of the plurality of inertial sensors according to the received processing information.

The present application is based on, and claims priority from JP Application Serial Number 2022-008515, filed Jan. 24, 2022, the disclosure of which is hereby incorporated by reference herein in its entirety.

### BACKGROUND

### 1. Technical Field

The present disclosure relates to an inertial sensor module.

### 2. Related Art

For example, JP-A-2010-284725 discloses that, as detection signals of inertial sensors for controlling an operation of a moving unit, detection signals of two inertial sensors having different detection ranges and resolutions are compared with set thresholds, and the detection signals of these inertial sensors are switched and selected.

However, in an output method for the detection signals described in JP-A-2010-284725, when a type and a specification of an output destination, for example, a vibration control unit that generates a control signal for controlling an operation of a moving unit from a detection signal of an inertial sensor differ, a detection signal of an inertial sensor to be selected is set in advance, and thus there is a problem that it is not possible to change the detection signal of the inertial sensor to be selected according to the output destination.

### SUMMARY

An inertial sensor module includes: a plurality of inertial sensors including a first inertial sensor and a second inertial sensor that have different detection ranges; a processing unit configured to process detection signals of the plurality of inertial sensors and output an inertial output; a transmission unit configured to transmit the inertial output to a host; and a reception unit configured to receive processing information from the host. The processing unit is configured to process at least one of the detection signals of the plurality of inertial sensors according to the received processing information.

### BRIEF DESCRIPTION OF THE DRAWINGS

FIG. 1 is a block diagram showing a configuration of an inertial sensor module according to a first embodiment.

FIG. 2 is a diagram showing noise characteristics of a first inertial sensor and a second inertial sensor that are provided in the inertial sensor module.

FIG. 3 is a diagram showing linearity errors of the first inertial sensor and the second inertial sensor that are provided in the inertial sensor module.

FIG. 4 is a flowchart showing a method for selecting a detection signal.

FIG. 5 is a block diagram showing a configuration of an inertial sensor module according to a second embodiment.

FIG. 6 is a flowchart showing a method for executing averaging processing on detection signals.

FIG. 7 is a flowchart showing a modification of the method for executing averaging processing on detection signals.

FIG. 8 is a block diagram showing a configuration of an inertial sensor module according to a third embodiment.

FIG. 9 is a flowchart showing a method for correcting a detection signal using a correction parameter.

FIG. 10 is a flowchart showing a modification of the method for correcting a detection signal using a correction parameter.

### DESCRIPTION OF EXEMPLARY EMBODIMENTS

### 1. First Embodiment

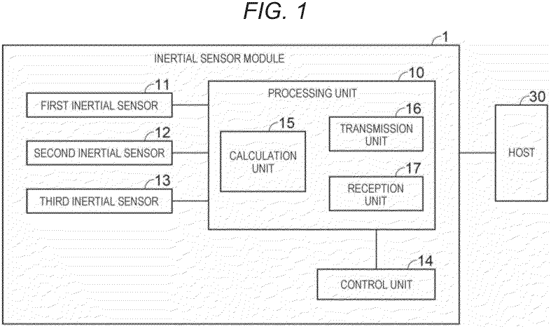

First, an inertial sensor module 1 according to a first embodiment will be described with reference to FIGS. 1, 2, and 3.

As shown in FIG. 1, the inertial sensor module 1 according to the present embodiment includes a processing unit 10, a plurality of inertial sensors 11, 12, and 13, and a control unit 14.

The processing unit 10 processes at least one of detection signals a1, a2, and a3 of the plurality of inertial sensors 11, 12, and 13 according to received processing information D, and outputs inertial outputs b1, b2, and b3. In the present embodiment, the inertial sensor module 1 including the processing unit 10 that selects and processes the detection signal a1 of the first inertial sensor 11 or the detection signal a2 of the second inertial sensor 12 and that outputs the inertial output b1 or the inertial output b2 will be described.

The plurality of inertial sensors 11, 12, and 13 are the first inertial sensor 11, the second inertial sensor 12, and the third inertial sensor 13. In the present embodiment, a gyro sensor that detects an angular velocity around a detection axis will be described as an example of the first inertial sensor 11 and the second inertial sensor 12, and an acceleration sensor that detects an acceleration in a detection axis direction will be described as an example of the third inertial sensor 13.

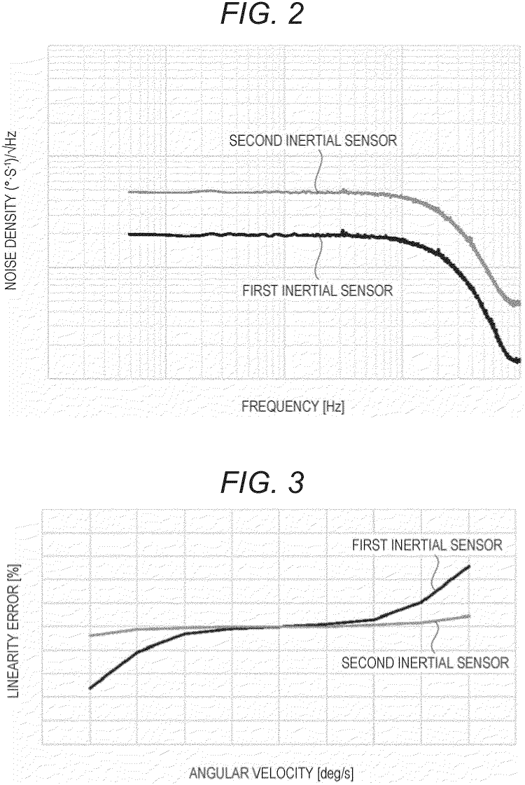

Detection ranges of the first inertial sensor 11 and the second inertial sensor 12 are different from each other, and the detection range of the first inertial sensor 11 is narrower than that of the second inertial sensor 12. In addition, noise in a noise characteristic of the first inertial sensor 11 is smaller than that of the second inertial sensor 12 as shown in FIG. 2, and a linearity error of the first inertial sensor 11 is larger than that of the second inertial sensor 12 as shown in FIG. 3.

The control unit 14 controls the processing unit 10 so as to process the detection signal a1 of the first inertial sensor 11 or the detection signal a2 of the second inertial sensor 12 according to the processing information D such as angular velocity data or acceleration data output from a host 30 and to output the inertial output b1 or the inertial output b2.

The processing unit 10 includes a calculation unit 15, a transmission unit 16, and a reception unit 17.

When the processing information D is smaller than a predetermined threshold F, according to a control signal from the control unit 14 generated based on the processing information D output from the host 30, the calculation unit 15 selects and processes the detection signal a1 of the first inertial sensor 11, and outputs the inertial output b1. In addition, when the processing information D is equal to or larger than the predetermined threshold F, the detection signal a2 of the second inertial sensor 12 is selected and processed, and the inertial output b2 is output.

The transmission unit 16 transmits the inertial outputs b1 and b2 processed by the processing unit 10 to the host 30.

The reception unit 17 receives the processing information D from the host 30.

The processing information D according to the present embodiment is the angular velocity data or the acceleration data, and may be posture data or position data. In addition, the inertial sensor module 1 uses two gyro sensors having different detection ranges, noise characteristics, and linearity errors, and may use two acceleration sensors having different detection ranges, noise characteristics, and linearity errors. Further, three or more gyro sensors or acceleration sensors having different detection ranges, noise characteristics, and linearity errors may be used. In addition, the inertial sensor 13 may be omitted.

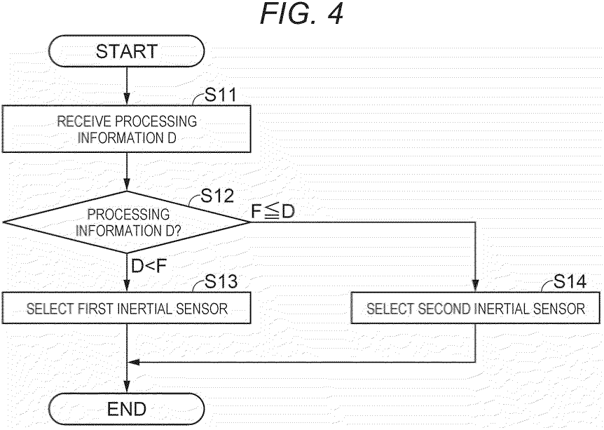

Next, a method for selecting the detection signals a1 and a2 in the inertial sensor module 1 will be described with reference to FIG. 4.

First, in step S11, the processing unit 10 receives the processing information D output from the host 30. Next, in step S12, the control unit 14 compares the processing information D with the predetermined threshold F stored in the control unit 14.

When the processing information D is less than the predetermined threshold F, in step S13, based on the control signal from the control unit 14 according to the processing information D, the calculation unit 15 selects and processes the detection signal a1 of the first inertial sensor 11, and outputs the inertial output b1.

When the processing information D is equal to or larger than the predetermined threshold F, in step S14, based on the control signal from the control unit 14 according to the processing information D, the calculation unit 15 selects and processes the detection signal a2 of the second inertial sensor 12, and outputs the inertial output b2.

As described above, the inertial sensor module 1 according to the present embodiment processes at least one of the detection signals a1 and a2 of the plurality of inertial sensors 11 and 12 according to the processing information D from the host 30 that is an output destination. Specifically, when the processing information D is smaller than the predetermined threshold F, the detection signal a1 of the first inertial sensor 11 is selected and processed, and when the processing information D is equal to or larger than the predetermined threshold F, the detection signal a2 of the second inertial sensor 12 is selected and processed. Therefore, since the detection signal a1 of the first inertial sensor 11 or the detection signal a2 of the second inertial sensor 12 can be selected and processed according to the processing information D of the output destination, it is possible to freely change the detection signals a1 and a2 of the inertial sensors 11 and 12 to be selected according to a type and a specification of a control method for the output destination.

### 2. Second Embodiment

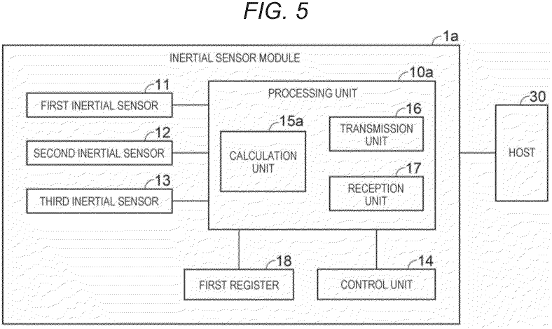

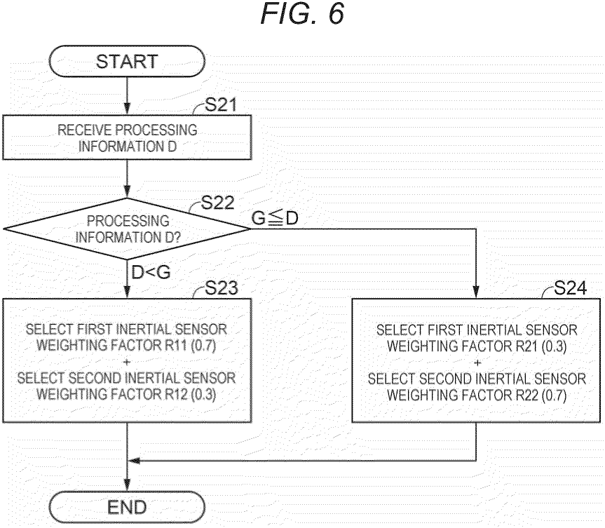

Next, an inertial sensor module 1a according to a second embodiment will be described with reference to FIGS. 5 and 6.

The inertial sensor module 1a according to the present embodiment is different from the inertial sensor module 1 according to the first embodiment in the method for processing the detection signals a1 and a2 in a calculation unit 15a in the processing unit 10a, and is the same as the inertial sensor module 1 according to the first embodiment except that the inertial sensor module 1a includes a first register 18. Differences from the first embodiment described above will be mainly described, and the description of similar matters will be omitted.

As shown in FIG. 5, the inertial sensor module 1a includes the processing unit 10a, the plurality of inertial sensors 11, 12, and 13, the control unit 14, and the first register 18.

The calculation unit 15a in the processing unit 10a switches a weighting factor R and executes averaging processing on the detection signals a1 and a2 of the plurality of inertial sensors 11 and 12 according to the processing information D.

Specifically, as shown in FIG. 6, in step S21, the processing unit 10a receives the processing information D output from the host 30. Next, in step S22, the control unit 14 compares the processing information D with a predetermined threshold G stored in the control unit 14.

When the processing information D is smaller than the predetermined threshold G, in step S23, according to the control signal from the control unit 14 based on setting information of the weighting factor R according to the processing information D, the calculation unit 15a adds the detection signal a1, which is obtained by selecting the detection signal a1 of the first inertial sensor 11 and multiplying a weighting factor R11, for example, 0.7, and the detection signal a2, which is obtained by selecting the detection signal a2 of the second inertial sensor 12 and multiplying a weighting factor R12, for example, 0.3, and outputs an addition result as an inertial output b11.

When the processing information D is equal to or larger than the predetermined threshold G, in step S24, according to the control signal from the control unit 14 based on the setting information of the weighting factor R according to the processing information D, the calculation unit 15a adds the detection signal a1, which is obtained by selecting the detection signal a1 of the first inertial sensor 11 and multiplying a weighting factor R21, for example, 0.3, and the detection signal a2, which is obtained by selecting the detection signal a2 of the second inertial sensor 12 and multiplying a weighting factor R22, for example, 0.7, and outputs an addition result as an inertial output b12.

The first register 18 sets and stores the setting information of the weighting factor R according to the processing information D.

With such a configuration, the inertial sensor module 1a according to the present embodiment can attain the same effects as those according to the inertial sensor module 1 of the first embodiment. In addition, by switching the weighting factor R and executing the averaging processing on the detection signals a1 and a2 of the two inertial sensors 11 and 12 based on the processing information D according to a type and a specification of a control method for an output destination, the inertial outputs b11 and b12 during sensor switching can be made smoother. The inertial sensor 13 is provided in the present embodiment, and the inertial sensor 13 may be omitted.

### 3. Modification of Second Embodiment

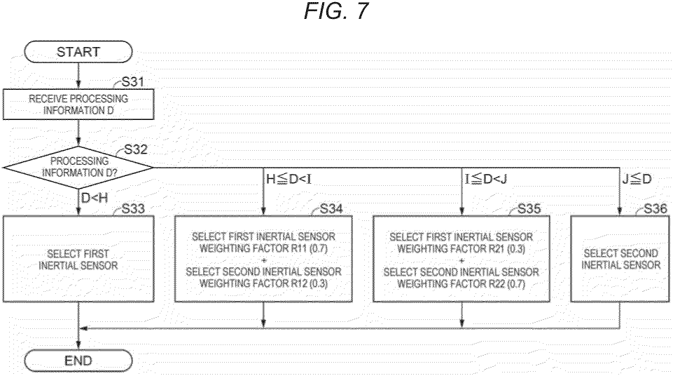

Next, a modification of the method for executing averaging processing on the detection signals a1 and a2 of the inertial sensor module 1a according to the second embodiment will be described with reference to FIG. 7.

In the modification, the detection signals a1 and a2 are processed by a method combining the method for selecting the detection signals a1 and a2 according to the processing information D in the first embodiment and the method for executing averaging processing on the detection signals a1 and a2 according to the processing information D in the second embodiment.

In the modification, as shown in FIG. 7, in step S31, the processing unit 10a receives the processing information D output from the host 30. Next, in step S32, the control unit 14 compares the processing information D with predetermined thresholds H, I, and J stored in the control unit 14.

When the processing information D is smaller than the predetermined threshold H, in step S33, based on the control signal from the control unit 14 according to the processing information D, the calculation unit 15a selects and processes the detection signal a1 of the first inertial sensor 11, and outputs the detection signal a1 as an inertial output b21.

When the processing information D is equal to or larger than the threshold H and smaller than the threshold I, in step S34, according to the control signal from the control unit 14 based on the setting information of the weighting factor R according to the processing information D, the calculation unit 15a adds the detection signal a1, which is obtained by selecting the detection signal a1 of the first inertial sensor 11 and multiplying the weighting factor R11, for example, 0.7, and the detection signal a2, which is obtained by selecting the detection signal a2 of the second inertial sensor 12 and multiplying the weighting factor R12, for example, 0.3, and outputs an addition result as an inertial output b22.

When the processing information D is equal to or larger than the threshold I and smaller than the threshold J, in step S35, according to the control signal from the control unit 14 based on the setting information of the weighting factor R according to the processing information D, the calculation unit 15a adds the detection signal a1, which is obtained by selecting the detection signal a1 of the first inertial sensor 11 and multiplying the weighting factor R21, for example, 0.3, and the detection signal a2, which is obtained by selecting the detection signal a2 of the second inertial sensor 12 and multiplying the weighting factor R22, for example, 0.7, and outputs an addition result as an inertial output b23.

When the processing information D is equal to or larger than the predetermined threshold J, in step S36, based on the control signal from the control unit 14 according to the processing information D, the calculation unit 15a selects and processes the detection signal a2 of the second inertial sensor 12, and outputs the detection signal a2 as an inertial output b24.

With such a configuration, effects equivalent to those of the inertial sensor module 1 according to the first embodiment can be attained. In addition, based on the processing information D according to a type and a specification of a control method for an output destination, the inertial outputs b21, b22, b23, and b24 during sensor switching can be made smoother.

### 4. Third Embodiment

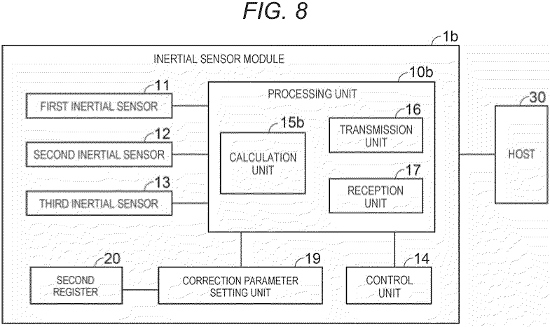

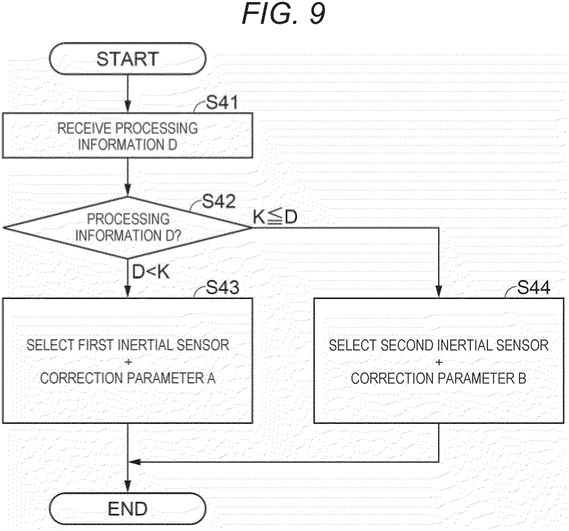

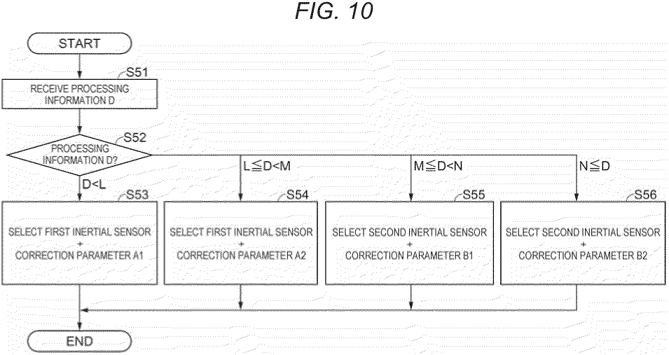

Next, an inertial sensor module 1b according to a third embodiment will be described with reference to FIGS. 8 and 9.

The inertial sensor module 1b according to the present embodiment is different from the inertial sensor module 1 according to the first embodiment in the method for processing the detection signals a1 and a2 in a calculation unit 15b in a processing unit 10b, and is the same as the inertial sensor module 1 according to the first embodiment except that the inertial sensor module 1b includes a correction parameter setting unit 19 and a second register 20. Differences from the first embodiment described above will be mainly described, and the description of similar matters will be omitted.

As shown in FIG. 8, the inertial sensor module 1b includes the processing unit 10b, the plurality of inertial sensors 11, 12, and 13, the control unit 14, the correction parameter setting unit 19, and the second register 20.

The calculation unit 15b in the processing unit 10b corrects the detection signals a1 and a2 of the plurality of inertial sensors 11 and 12 using correction parameters A and B according to the processing information D.

Specifically, as shown in FIG. 9, in step S41, the processing unit 10b receives the processing information D output from the host 30. Next, in step S42, the control unit 14 compares the processing information D with a predetermined threshold K stored in the control unit 14.

When the processing information D is smaller than the predetermined threshold K, in step S43, according to the control signal from the control unit 14 and the correction parameter A read from the correction parameter setting unit 19 according to the processing information D, the calculation unit 15b selects the first inertial sensor 11 and adds the correction parameter A to the detection signal a1, and outputs an addition result as an inertial output b31.

When the processing information D is equal to or larger than the predetermined threshold K, in step S44, according to the control signal from the control unit 14 and the correction parameter B read from the correction parameter setting unit 19 according to the processing information D, the calculation unit 15b selects the second inertial sensor 12 and adds the correction parameter B to the detection signal a2, and outputs an addition result as an inertial output b32.

The correction parameter setting unit 19 sets the correction parameters A and B according to the processing information D.

The second register 20 sets and stores setting information of the correction parameters A and B according to the processing information D.

With such a configuration, the inertial sensor module 1b according to the present embodiment can attain the same effects as those of the inertial sensor module 1 according to the first embodiment. In addition, by correcting the detection signals a1 and a2 of the selected inertial sensors 11 and 12 using the correction parameters A and B based on the processing information D according to a type and a specification of a control method for an output destination, the inertial outputs b31 and b32 during sensor switching can be made smoother.

### 5. Modification of Third Embodiment

Next, a modification of the method for correcting the detection signals a1 and a2 of the inertial sensor module 1b according to the third embodiment using the correction parameters A and B will be described with reference to FIG. 10.

In the modification, the detection signals a1 and a2 are processed using four correction parameters A1, A2, B1, and B2 in the method for correcting the detection signals a1 and a2 using the two correction parameters A and B according to the processing information D in the third embodiment.

In the modification, as shown in FIG. 10, in step S51, the processing unit 10b receives the processing information D output from the host 30. Next, in step S52, the control unit 14 compares the processing information D with predetermined thresholds L, M, and N stored in the control unit 14.

When the processing information D is smaller than the predetermined threshold L, in step S53, according to the control signal from the control unit 14 and the correction parameter A1 read from the correction parameter setting unit 19 according to the processing information D, the calculation unit 15b selects the first inertial sensor 11 and adds the correction parameter A1 to the detection signal a1, and outputs an addition result as an inertial output b41.

When the processing information D is equal to or larger than the threshold L and less than the threshold M, in step S54, according to the control signal from the control unit 14 and the correction parameter A2 read from the correction parameter setting unit 19 according to the processing information D, the calculation unit 15b selects the first inertial sensor 11 and adds the correction parameter A2 to the detection signal a2, and outputs an addition result as an inertial output b42.

When the processing information D is equal to or larger than the threshold M and less than the threshold N, in step S55, according to the control signal from the control unit 14 and the correction parameter B1 read from the correction parameter setting unit 19 according to the processing information D, the calculation unit 15b selects the second inertial sensor 12 and adds the correction parameter B1 to the detection signal a1, and outputs an addition result as an inertial output b43.

When the processing information D is equal to or larger than the predetermined threshold N, in step S56, according to the control signal from the control unit 14 and the correction parameter B2 read from the correction parameter setting unit 19 according to the processing information D, the calculation unit 15b selects the second inertial sensor 12 and adds the correction parameter B2 to the detection signal a2, and outputs an addition result as an inertial output b44.

With such a configuration, effects equivalent to those of the inertial sensor module 1 according to the first embodiment can be attained. In addition, based on the processing information D according to a type and a specification of a control method for an output destination, the inertial outputs b41, b42, b43, and b44 during sensor switching can be made smoother.

What is claimed is:

1. An inertial sensor module comprising:
a plurality of inertial sensors including a first inertial sensor and a second inertial sensor that have different detection ranges;
a processing unit configured to process detection signals of the plurality of inertial sensors and output an inertial output;
a transmission unit configured to transmit the inertial output to a host; and
a reception unit configured to receive processing information from the host, wherein
the processing unit is configured to process at least one of the detection signals of the plurality of inertial sensors according to the received processing information.

2. The inertial sensor module according to claim 1, wherein
the processing unit includes a calculation unit, and
the calculation unit is configured to select and process the detection signal of the first inertial sensor when the processing information is smaller than a predetermined threshold, and select and process the detection signal of the second inertial sensor when the processing information is equal to or larger than the predetermined threshold.

3. The inertial sensor module according to claim 1, wherein
the processing unit includes a calculation unit, and
the calculation unit is configured to set a weighting factor according to the processing information and execute averaging processing on the detection signals of the plurality of inertial sensors using the selected weighting factor.

4. The inertial sensor module according to claim 3, further comprising:
a first register configured to set setting information of the weighting factor.

5. The inertial sensor module according to claim 1, wherein
the processing unit includes a correction parameter setting unit and a calculation unit,
the correction parameter setting unit is configured to set a correction parameter according to the processing information, and
the calculation unit is configured to correct the detection signals of the plurality of inertial sensors using the correction parameter.

6. The inertial sensor module according to claim 5, further comprising:
a second register configured to set setting information of the correction parameter.

7. The inertial sensor module according to claim 1, wherein
the processing information is angular velocity data or acceleration data.

8. The inertial sensor module according to claim 1, wherein
the processing information is posture data or position data.

9. The inertial sensor module according to claim 1, wherein
noise of the first inertial sensor is smaller than that of the second inertial sensor, and
a linearity error of the first inertial sensor is larger than that of the second inertial sensor.
